(19) United States
(12) Patent Application Publication
(10) Pub. No.: US 2006/0282293 A1
(43) Pub. Date: Dec. 14, 2006

(54) System and method for providing automated notification of hospital admissions

(76) Inventors: Sandra Lynn True, St. Charles, IL (US); David S. Benco, Winfield, IL (US); Sanjeev Mahajan, Naperville, IL (US); Baoling S. Sheen, Naperville, IL (US)

Correspondence Address: FAY SHARPE/LUCENT, 1100 SUPERIOR AVE, SEVENTH FLOOR, CLEVELAND, OH, 44114, US

(21) Appl. No.: 11/150,019

(22) Filed: Jun. 10, 2005

(51) Int. Cl. G06F 19/00

(52) U.S. Cl. 705/3

(57) ABSTRACT

A method for notifying a religious contact designated by a subscriber that the subscriber has been admitted to a hospital is provided. The method includes determining that a person is an admitted patient admitted to a hospital, determining that the admitted patient subscribes to a hospital admission notification service, retrieving a stored identification of a religious contact designated by the patient, retrieving a contact number for the designated religious contact, and sending an automated notification message to the contact number via a telecommunications network notifying the designated religious contact of the admitted patient's hospital admission.

### BACKGROUND OF THE INVENTION

This invention relates to a system and method for providing an automated notification of a person's hospital admission.

While the invention is particularly directed to the art of telecommunications systems, and will be thus described with specific reference thereto, it will be appreciated that the invention may have usefulness in other fields and applications. For example, the invention may be used with wireless telecommunications systems.

Hospitals provide a wide range of medical care to people. Usually, a person receiving medical care in a hospital is admitted to the hospital as a patient. During the admissions process, information about the patient is collected for use in identifying the patient, for billing purposes and for ensuring that the patient receives the proper care. Hospital admissions staff typically collect the admissions information either from the patient, from those accompanying the patient, from the patient's physician, or from other sources. In emergencies, admissions information can even be obtained from the patient's drivers license or identification card when the patient is unable to provide it.

A patient's hospital admission may be planned such as when the patient undergoes a planned surgery, receives scheduled medical tests, or undergoes other foreseen medical procedures. Alternatively, a. person's admission to a hospital may be unplanned due to a sudden illness, an accident, or other unforeseen occurrences.

For many patients, a hospital stay can be an unsettling experience which may be eased by a visit from their clergy, their rabbi, their spiritual advisor or other religious counsel. For emergencies and other unplanned admissions, there might be an immediate need to have the religious counsel of their choice come to the hospital to offer spiritual support or even administer last rights. For planned admissions, the timing of this visit may not be as immediate, but nonetheless, a visit of offer prayer or other religious services for the patient may be desirable.

As a result, there is a need to provide notification to a religious contact of the patient's choosing that the patient has been admitted to the hospital. The present invention contemplates a new and improved system and method that satisfies this need and others.

### SUMMARY OF THE INVENTION

A system and method for notifying a religious contact designated by a subscriber that the subscriber has been admitted to a hospital are provided.

In accordance with one aspect of the invention, the method includes determining that a person is an admitted patient admitted to a hospital, determining that the admitted patient subscribes to a hospital admission notification service, retrieving a stored identification of a religious contact designated by the patient, retrieving a contact number for the designated religious contact, and sending an automated notification message to the contact number via a telecommunications network notifying the designated religious contact of the admitted patient's hospital admission.

In accordance with another aspect of the invention, the system includes means for determining that a person is an admitted patient admitted to a hospital, means for determining that the admitted patient subscribes to a hospital admission notification service, means for retrieving stored contact information for a designated religious contact designated by the admitted patient, and means for sending an automated notification message to a designated religious contact using the contact information via a telecommunications network notifying the designated religious contact of the admitted patient's hospital admission.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a block diagram of a system for providing automated notification of a person's hospital admission to a designated religious contact;

FIG. 2 is a flow chart illustrating a portion of a method for providing this automated notification;

FIG. 3 is a flow chart illustrating the enrollment of a subscriber in a hospital admissions notification service described herein; and

FIG. 4 is a flow chart illustrating a portion of the method for providing the automated hospital admission notification to a religious contact designated by the subscriber.

### DETAILED DESCRIPTION OF THE PREFERRED EMBODIMENTS

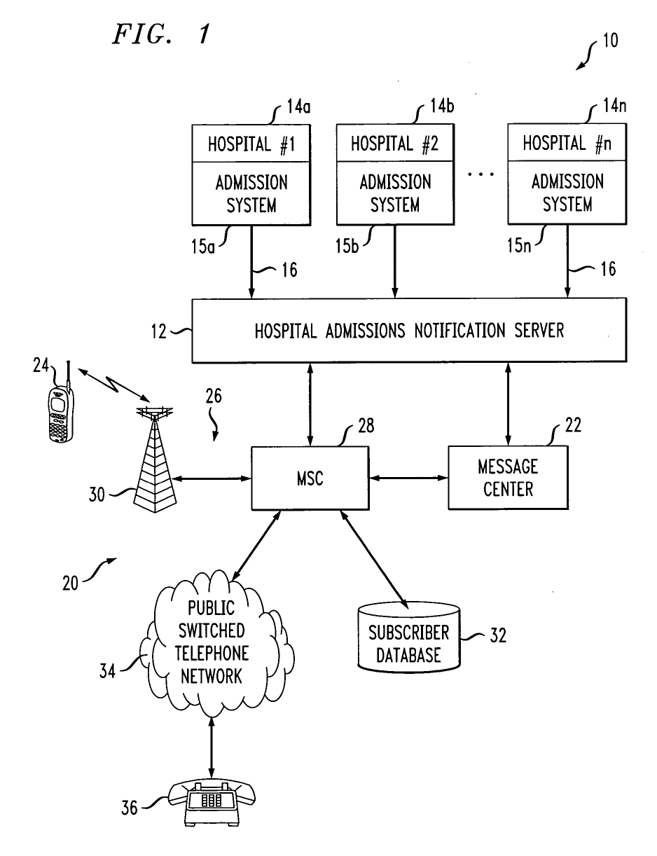

Referring now to FIG. 1 a system for providing an automated hospital admissions notification service to subscribers is shown generally at 10. As shall be described in further detail below, persons subscribing to the notification service are referred to as subscribers.

The system 10 includes Hospital Admissions Notification Server 12 connected to one or more hospitals 14. In the example provided herein, the server 12 is centralized and connected to a plurality of hospitals, shown as Hospital #1 referred to as 14a through Hospital #n referred to as 14n, via network connections 16. The Hospital Admissions Notification Server 12 can be any suitable computing device capable of performing the functions described herein. The network connections 16 can be Local Area Network (LAN) connections, Wide Area Network (WAN) connections, Internet connections, or other connections suitable for transmitting data therebetween.

The hospitals 14a-14n include corresponding admission systems 15a-15n for admitting people as patients to the hospitals. The admission systems 15a-15n can be computer operated processes for receiving admissions information entered by hospital personnel.

The Hospital Admissions Notification Server 12 is connected to a message center 22 for sending automated messages over a telecommunications network portions of which are shown generally at 20. The message center 22 can be part of the Hospital Admissions Notification Server 12 or it can be separated therefrom and connected thereto to enable communication therebetween.

Examples of the Message Center 22 can include, but are not limited to, a Short Message Service Center (SMSC) for sending Short Message Service (SMS) messages to terminals, such as the wireless mobile terminal 24, via a wireless telecommunications network, portions of which are shown generally at 26. The wireless telecommunications network 26 includes a Mobile Switching Center 28 connected to the Message Center 22 in a known manner for transmitting messages to the mobile terminal 12 via a base station 30. The Mobile Switching Center (MSC) 28 is responsible for handling the wireless communications to and from a mobile terminal 24 including such known functions as call setups and call routing, among others. The MSC 28 is typically connected to several base stations, only one of which is shown at 30 for simplicity, each typically providing coverage for different geographic areas so as to provide over-the-air communications between the MSC 28 and wireless terminals located near them.

The wireless telecommunications network 26 also includes a subscriber database 32. The subscriber database 32 can be disposed at the MSC 28, or on other nodes in the network 26. The subscriber database 32 can include individual subscriber records, current status of subscribers, and information on call routing and billing. The subscriber database 26 can also include the features which the subscriber subscribes to and can be used to determine whether a subscriber is authorized to use the hospital admissions notification service described herein.

The Mobile Switching Center 28 can transmit the message, such as an automated voice message, from the Message Center 22 to the Public Switched Telephone Network 34 to a telephone 36 connected thereto.

The message center 22 can also include a Packet Data Serving Node which functions as a connection point between packet networks, such as IP networks, and the Radio Access of wireless telecommunications networks for sending messages therebetween. The message center 22 can generate and send automated voice messages to terminals, such as the mobile terminal 24 via the wireless communications network 26, or to landline terminals 36 or other mobile terminals (not shown) via the Public Switched Telephone network 34. The automated voice messages can be sent to these terminals 24 and 36 via contact numbers such as their corresponding telephone numbers.

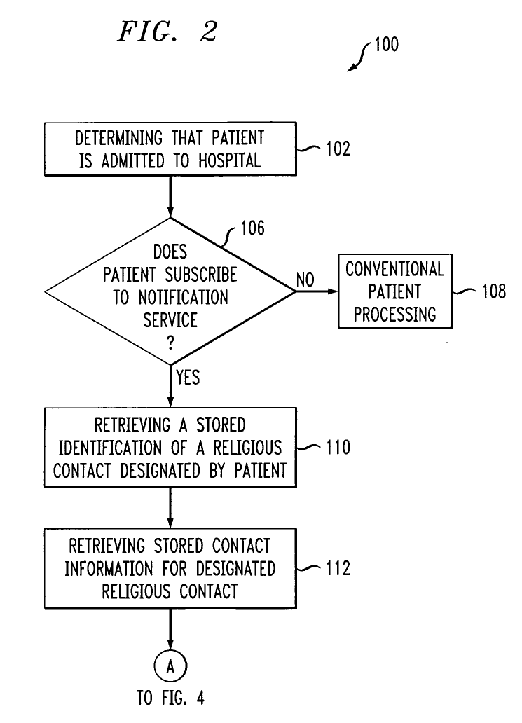

Referring now to FIG. 2, a portion of method for automatically notifying a religious contact that a person has been admitted to a hospital is shown generally at 100. The religious contact is a designated religious contact in that they are designated by the person for automatically receiving this notification when the person is admitted. The designated religious contact can be any religious or spiritual advisor or counselor, a priest, a rabbi, a cleric, clergy, etc. associated with the person.

The method 100 includes determining that the person has been admitted to a hospital at 102. The admitted person is referred to herein as a patient, or an admitted patient. In the example provided herein, the person is admitted as a patient in Hospital #2 14b, though it should be appreciated that the person can be admitted to any of the hospitals 14a-14n described above. The patient's admission information is collected by the admission system 15b at the hospital 14b. The admission information includes the patient's name and other pertinent information collected for providing proper care for the patient, for billing purposes, for insurance matters, or for contacting family members, if desired. The hospital 14b conveys at least some of the admission information, including the patient's name, to the Hospital Admissions Notification Server 12 during or after the patient's admission. Upon receiving this information the Server 12 determines that the patient has been admitted. The admission information can also include an identification of the admitting hospital, Hospital #2 14b, and other information such as the date and time of admission. The admission information conveyed to the Hospital Admissions Notification Server 12 by Hospital #2 14b can also include a determination of the patient's condition, for purposes described below, or the patient's condition information can be sent separately.

The Hospital Admissions Notification Server 12 determines whether the patient has subscribed to the notification service at 106 using the admission information, such as the patient's name, in a look up table or in other suitable manners. An indication that the patient has subscribed to the notification service can be stored at the Hospital Admissions Notification Server 12 and associated with the patient, such as by name. Alternatively, this indication can be stored in the wireless communications network subscriber database 32 and the Hospital Admissions Notification Server 12 can query the subscriber database to determine if the patient has subscribed. If the patient has not subscribed to the notification service, conventional patient processing is performed at 108.

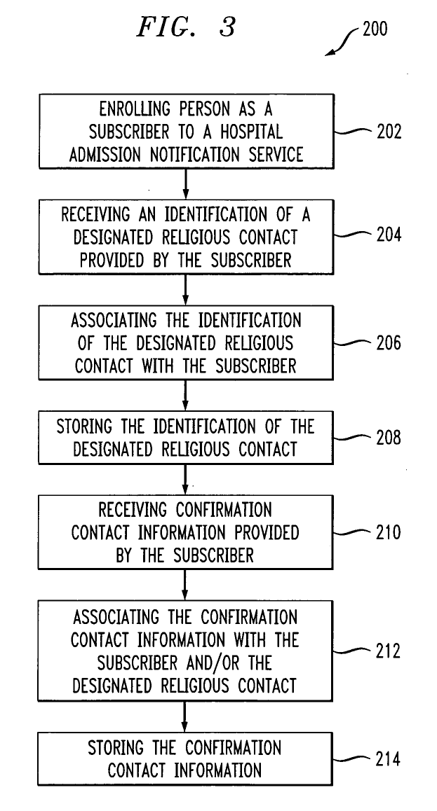

Referring now to FIG. 3, an example of at least some of the information collected from a person subscribing to the admission notification service is shown generally at 200. Typically, the person will subscribe to this service prior to being admitted. The person enrolls as a subscriber to the hospital admission notification service at 202. This service can be provided by a wireless telecommunications provider, or by another party, which ca be responsible for operating the Hospital Admissions Notification Server 12. A subscription fee for this service can be charged to subscribers, or this service can be bundled together with other services which may be charged for collectively. In the example described herein, the subscriber provides the information used by the notification service to the Hospital Admissions Notification Server 12 while enrolling. However, it should be appreciated that the information can be provided to other nodes in the communications networks 20, 26 such as, for example, the subscriber database 32. This information can be provided using a mobile terminal, using an Internet connection, via voice commands, or in other known manners suitable for providing such information.

The subscriber designates the religious contact of their choice who will be notified of their hospital admission by providing an identification of the contact, such as the religious contact's name. The designated religious contact's identification is received by the Hospital Admissions Notification Server 12 at 204, associated with the subscriber at 206, and stored at the Hospital Admissions Notification Server at 208 such as, for example, in a look up table or in other suitable manners. Other information can be provided by the subscriber and stored in the Hospital Admissions Notification Server 12 including the religious affiliation of the designated religious contact, a secondary contact number, and an indication by the subscriber of whether they want confirmation of the notification to be sent out.

If so, the subscriber can provide confirmation contact information which is received by the Hospital Admissions Notification Server 12 at 210. The confirmation contact information can include a contact number, such as a landline or mobile phone number, of the person who will receive confirmation that the designated religious contact has been notified, as described in further detail below. The confirmation contact information is associated with the subscriber and/or the designated religious contact at 212 and stored at the Hospital Admissions Notification Server 12 at 214.

Referring again to FIG. 2, once it is determined that the admitted patient subscribes to the hospital admissions notification service at 106, the Hospital Admission Notification Server 12 retrieves the stored identification of the designated religious contact at 110 and retrieves the stored contact information, including the contact number, for the designated religious contact at 112.

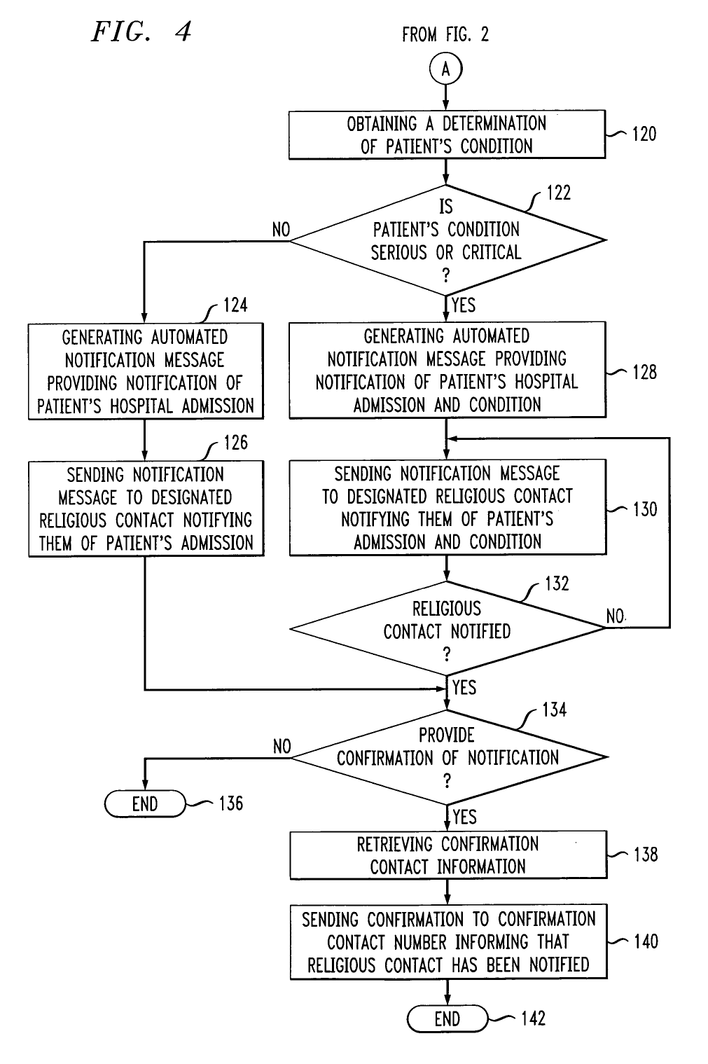

Referring now to FIG. 4 a determination of the patient's condition, as determined, for example by the hospital's medical staff such as the patient's physician, is obtained by the Hospital Admissions Notification Server 12 at 120. This information can be conveyed from the hospital to the Hospital Admissions Notification Server 12 via connection 16. As mentioned above it can be included with the admissions information described above, or it can be conveyed separately.

If it is determined that the patient's condition is not critical and not serious, there may be less urgency for notifying the designated religious contact and different steps can be taken, if so desired. In this example, a notification message providing notification of the patient's admission to Hospital #2 14b is automatically generated by the message center 22 at 124 using the hospital admissions information provided in step 104 and the designated religious contact information retrieved in steps 110 and 112. This automated notification message can be an SMS message generated by an SMSC, or an automated voice message generated in a known manner by a suitable a Message Center capable of generating automated voice messages. The notification message is sent to the contact number of the religious contact at 126.

If it is determined at 122 that the patient's condition is serious or critical, an automated message is generated by the message center 22 at 128 providing notification of the patient's hospital admission and notification of the patient's condition. The message can be an SMS message, or an automated voice message. The message is sent to the contact number of the religious contact at 130, such as a mobile terminal 24 or a landline terminal 36. Since the patient's condition is critical or serious, there is a greater urgency for notifying the religious contact so that they can come to the hospital more quickly. As a result, it is determined at 132 whether the religious contact has been notified. This can be determined by checking for an acknowledgement of receipt of the message from the religious contact. If it is determined that the religious contact has not been notified at 132, the message is sent again and these two steps, 130 and 132, are repeated until it is determined that the religious contact has been notified at 132.

Next, it is determined at 134 whether confirmation of this notification is to be provided. If no confirmation is to be provided, the notification service is ended at 134. If confirmation is to be provided, the confirmation contact information is retrieved at 138 and a confirmation message is automatically generated by the message center 22 and sent to the confirmation contact number at 140, which can be to a mobile phone 24 or a landline phone 36, informing the recipient that the designated religious contact has been notified. The recipient can be a family member, a hospital staff member, or the patient, among others. The service ends at 142 after sending the confirmation of notification.

The system and method for providing hospital admission notification to a designated religious contact integrates the telecommunications network 20 with hospital admission systems 15a-15n to quickly and automatically notify a religious contact who is designated by the subscriber. The notification service is suitable for both planned and unplanned hospital admissions. It provides a subscriber the convenience of being able to have their designated religious contact automatically notified via a phone call to the religious contact's contact number, or via an SMS message sent to the contact number. The notification could have varying messages that would describe the level of the patient's condition so that the clergy could assess whether the need for a visit was immediate or not. The Hospital Admissions Notification Server 12 serves as a point of control and is connected to the telecommunications network 20, 26 for providing this notification and confirmation of the notification.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A method comprising:
determining that a person is an admitted patient admitted to a hospital;
determining that the admitted patient subscribes to a hospital admission notification service;
retrieving a stored identification of a religious contact designated by the patient;
retrieving a contact number for the designated religious contact; and
sending an automated notification message to the contact number via a telecommunications network notifying the designated religious contact of the admitted patient's hospital admission.

2. The method defined in claim 1 further comprising obtaining a determination that the admitted patient's condition is critical or serious;
determining if the designated religious contact has received the notification message; and
periodically repeating the steps of sending the automated notification message and determining if the designated religious contact has received the automated notification message until the designated religious contact has received the automated notification message.

3. The method defined in claim 2 wherein the step of determining if the designated religious contact has received the automated notification message includes checking for an acknowledgement acknowledging receipt of the automated notification message.

4. The method defined in claim 2 further comprising:
enrolling the person as a subscriber in the hospital admission notification service;
receiving the identification of the designated religious contact from the subscriber;
storing the identification of the designated religious contact;
receiving the contact number for the designated religious contact from the subscriber; and
storing the contact number.

5. The method defined in claim 4 further comprising:
receiving confirmation contact information from the subscriber, wherein the confirmation contact information includes a confirmation contact number; and
storing the confirmation contact information.

6. The method defined in claim 5 further comprising:
retrieving the stored confirmation contact information for the admitted patient including the confirmation contact number; and
sending an automated confirmation message to the confirmation contact number indicating that the designated religious contact has been notified of the admitted patient's hospital admission.

7. The method defined in claim 1 further comprising
sending a message to a medical staff member indicating that the admitted patient's designated religious contact has been notified of the admitted patient's hospital admission.

8. The method defined in claim 2 further comprising
sending a message to a medical staff member indicating that the admitted patient's designated religious contact has been notified of the admitted patient's hospital admission and condition.

9. The method defined in claim 5 further comprising
retrieving the stored confirmation contact information for the admitted patient including the confirmation contact number; and
sending an automated confirmation message to the confirmation contact number indicating that the designated religious contact has been notified of the admitted patient's hospital admission and condition.

10. The method defined in claim 1 wherein the step of determining that a person is an admitted patient admitted to a hospital further comprises receiving an indication from the hospital that the patient was admitted.

11. The method defined in claim 1 wherein the step of sending an automated notification message includes sending an SMS message.

12. The method defined in claim 1 wherein the step of sending an automated notification message includes sending an automated voice message.

13. A method of providing notification of a person's hospital admission comprising:
enrolling a person as a subscriber to a hospital admission notification service;
receiving the identification of a designated religious contact from the subscriber;
storing the identification of the designated religious contact;
receiving contact information for the designated religious contact, wherein the contact information includes a contact number;
storing the contact information;
determining that the person is an admitted patient admitted to a hospital;
determining that the admitted patient subscribes to the hospital admission notification service;
retrieving the stored the identification of the designated religious contact and the stored contact information; and
sending an automated notification message to the designated religious contact using the contact information via a telecommunications network notifying the designated religious contact of the admitted patient's hospital admission.

14. A system comprising:
means for determining that a person is an admitted patient admitted to a hospital;
means for determining that the admitted patient subscribes to a hospital admission notification service;
means for retrieving stored contact information for a designated religious contact designated by the admitted patient; and
means for sending an automated notification message to a designated religious contact using the contact information via a telecommunications network notifying the designated religious contact of the admitted patient's hospital admission.

15. The system defined in claim 14 further comprising
means for obtaining a determination that the admitted patient's condition is critical or serious;
means for determining if the designated religious contact has received the notification message; and
means for repeatedly sending the automated notification message until the religious contact receives the notification message.

16. The system defined in claim 14 further comprising:
means for enrolling the person as a subscriber to the hospital admission notification service;
means for receiving the identification of the designated religious contact from the subscriber;
means for storing the identification of the designated religious contact;
means for receiving the contact information including the contact number for the designated religious contact from the subscriber; and
means for storing the contact information.

17. The system defined in claim 16 further comprising:
means for receiving confirmation information from the subscriber, wherein the confirmation information includes a confirmation contact number; and
means for associating the confirmation information with the subscriber; and
means for storing the confirmation information.

18. The system defined in claim 17 further comprising:
means for retrieving the stored confirmation information including the confirmation contact number; and
means for sending an automated confirmation message to the confirmation contact number indicating that the religious contact has been notified of the admitted patient's hospital admission.

19. The system defined in claim 15 further comprising:
means for retrieving stored confirmation information provided by the patient including a confirmation contact number; and
means for sending an automated confirmation message to the confirmation contact number indicating that the religious contact has been notified of the admitted patient's hospital admission and condition.

20. The system defined in claim 14 further comprising:
means for sending a message to a medical staff member indicating that the admitted patient's designated religious contact has been notified of the admitted patient's hospital admission.
